(19) United States
(12) Patent Application Publication
(10) Pub. No.: US 2021/0317654 A1
(43) Pub. Date: Oct. 14, 2021

(54) EMBEDDED ANCHOR

(71) Applicant: Jiangsu Ernest Technology Co. Ltd., Jiangsu (CN)

(72) Inventor: Desheng Lu, Fujian (CN)

(73) Assignee: Jiangsu Ernest Technology Co. Ltd., Jiangsu (CN)

(21) Appl. No.: 16/319,913

(22) PCT Filed: Jul. 26, 2017
(86) PCT No.: PCT/CN2017/094427

§ 371 Date: Jun. 13, 2019

(30) Foreign Application Priority Data
Jul. 26, 2016 (CN) 201620794350.4

(51) Int. Cl. E04B 1/41

(52) U.S. Cl. CPC E04B 1/4114

(57) ABSTRACT

An embedded anchor by which fixtures including suspension rods, studs and other steel work can be secured to a concrete structure includes a male insert (10) to which the fixtures are connected and a female ferrule (12) to receive the insert (10). The female ferrule (12) is adapted to be permanently embedded in the concrete structure. The insert (10) is associated with one or more spring loaded pins (14, 16). The ferrule (12) includes apertures (22) positioned to receive the pins (14, 16). The pins (14, 16) are pushed against a spring (30) to allow the insert (10) to be slid into the ferrule (12), and the pins (14, 16) spring outwardly to engage the apertures (22) locking the insert (10) in the ferrule (12) to secure the fixture to the concrete structure.

### TECHNICAL FIELD

This invention relates to building components, in particular, but not exclusively to an embedded anchor for hanging fixtures or securing steel work to structures. In particular, the invention relates to a female member which is embedded in concrete that is adapted to receive a male insert to which the fixture is connected.

### BACKGROUND

The problems of anchoring fixtures to concrete structures are well known. In almost all cases, limitations are due to the load bearing capacities of the devices affixed to or embedded in the structure to which the fixture is secured. It is often a problem where the design of the anchor device is defective and does not provide sufficient holding power in the concrete resulting in the device being pulled out under load. Most prior art anchors require the fixture to be screwed in to the embedded anchor after the concrete has been placed. The thread in the embedded anchor can often be contaminated by concrete laitance which requires removing before the threads can be engaged. Also there is a risk of damage to the threads which can cause delays. These delays can occur at critical times in the project and may hold up other works. In some cases, installers do not properly remedy the above problems. This can have disastrous consequences where heavy overhead fixtures are suspended from a great height for example, overhead stage equipment and lighting such as in an auditorium or venue. Other examples include false ceilings in buildings which may conceal pipes and cables which are themselves suspended from the soffit of the level above. There are other applications for example in the architectural or marine architectural industries where stainless steel and designer fixtures are becoming more common. Examples include the use of marine type fittings in balustrading and for suspended staircases.

In other cases such as in high rise buildings heavy plant and equipment such as air conditioning and heating units may be suspended on frames or rails between floors. Awnings, vertical surfaces, lift core guide rails (and other supports) depend on strong reliable anchors.

### SUMMARY

There is therefore a need for a strong and reliable anchor device that can be embedded in a structure that is easy to use and from which a not insubstantial fixture or load may be safely supported.

It is therefore an object of the invention to provide a novel and innovative solution for anchor a fixture to a concrete structure which seeks to address some of the disadvantages and/or of the prior art or to at least provide the public with an alternative and useful choice.

In one aspect, the invention resides in an embedded anchor to which a fixture including suspension rods, studs and other steel work can be secured to a concrete structure, comprising:

a male insert to which the fixture is to be connected;

a female ferrule configured to receive the insert; the female ferrule adapted to be embedded in the concrete structure;

the insert associated with one or more spring loaded pins housed in wells in the insert;

the ferrule including one or more apertures positioned to receive the one or more pins;

the pins are pushed in against a compression spring to allow the insert to be slid into the ferrule, wherein the pins spring outwardly on engaging the one or more apertures thereby locking the insert in the ferrule to secure the fixture to the concrete structure.

In an exemplary embodiment, the pins are secured in the insert by spring coils which are force fitted into eccentric partial grooves in the wells wherein a portion of the coils are exposed to engage blind ended grooves in the pins thereby retaining the pins in the wells against the compression spring.

In an exemplary embodiment, the insert is pre cast on one side with a complementary protrusion to engage a pin groove of a first pin wherein insertion of the first pin and spring is followed by a second pin on the opposite side; both pins secured by a single force fitted coil which retains the second pin and wherein the insert, pins and spring are supplied as a pre-assembled unit.

In an exemplary embodiment, the ferrule is of a hollow tubular configuration with a blanked off upper portion to prevent concrete from entering the ferrule and filling the apertures as it is being embedded in wet concrete.

The ferrule is blanked off to allow concrete to fill the upper portion of the ferrule which prevents it from collapsing inwardly under load.

In an exemplary embodiment, the upper portion of the ferrule is wider or is of a larger size to prevent the ferrule when embedded from being pulled out of the concrete structure under load.

In an exemplary embodiment, the upper portion is of an inverted tubular frusta conical configuration which permanently locks the ferrule in the concrete structure.

In an exemplary embodiment, suitably, there is a hole in the blanked off section to allow air to escape as it is displaced by the wet concrete entering the ferrule.

In an exemplary embodiment, the ferrule is associated with adhesive stickers or an outer sleeve to prevent concrete from entering the one or more apertures as the ferrule is embedded in wet concrete.

In an exemplary embodiment, the insert is associated with a removable sleeve which restrains the spring-loaded pins in the retracted position until it is dislodged as the insert enters the ferrule to allow the pins to be released and to engage the apertures of the ferrule.

In an exemplary embodiment, the pins are in a paired and in a transversely opposed arrangement.

In an exemplary embodiment, the pins have bevelled, domed or rounded ends and the apertures have correspondingly bevelled or chamfered mouths to facilitate entry and full deployment of the pins in the apertures.

In an exemplary embodiment, the insert may include a female screw thread into which a bolt or threaded rod attaching the fixture is screwed.

In an exemplary embodiment, suitably, the number of apertures of the ferrule and the number of pins of the insert depend on the tensile load specified to be carried by the suspended fixtures.

In an exemplary embodiment, suitably, the dimensions of the pins and apertures likewise depend on the specified loading requirements. Accordingly, the diameter of the pins and the holes are also determined by the shear or tensile load required to be borne by the pins.

In an exemplary embodiment, suitably, the insert and the ferrule are of a complementary shape or configuration to ensure the insert is correctly inserted in the ferrule and the pins are aligned with the one or more apertures.

In an exemplary embodiment, the insert and the ferrule are of an elliptical shape or configuration to ensure the insert will be correctly inserted into the ferrule.

In an exemplary embodiment, the insert and the ferrule can be of a rectangular, or other non-ellipsoid or non-cylindrical configuration.

### BRIEF DESCRIPTION OF DRAWINGS

In order for the invention to be better understood and put into practical effect reference will now be made to the accompanying illustrations, wherein:

FIGS. 1a and 1b show an exploded perspective view of an embodiment of the invention.

FIGS. 2a and 2b show a cross-section of the example of FIGS. 1a and 1b.

FIG. 3 shows a cross-section of the example of FIGS. 1a and 1b in the operating position.

FIG. 4 shows detail of a pin according to an embodiment of the invention.

FIGS. 5a-5c show details of an insert according to an embodiment of the invention.

FIG. 6a and FIG. 6b show further details of the insert of FIGS. 5a-5c.

### DETAILED DESCRIPTION

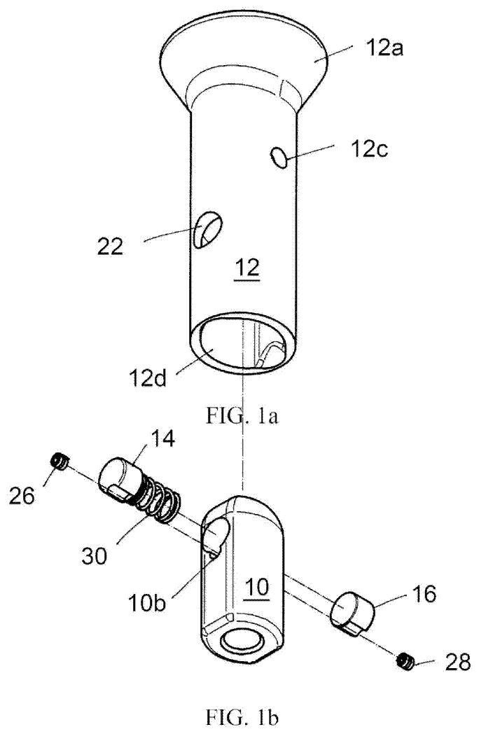

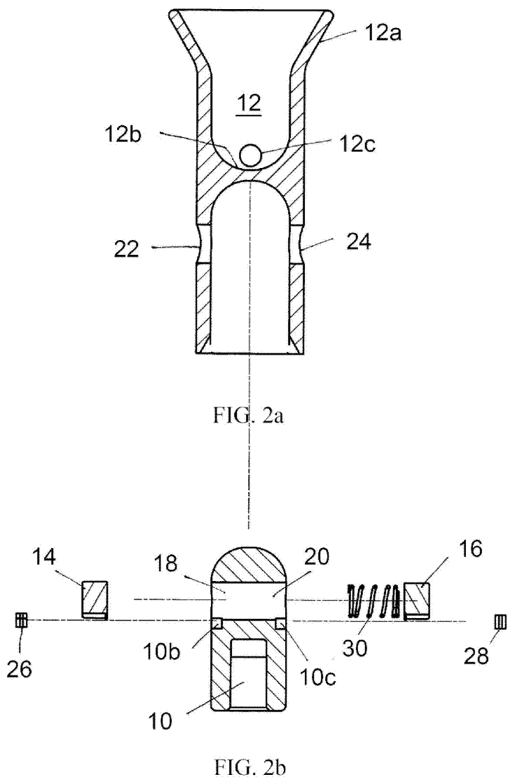

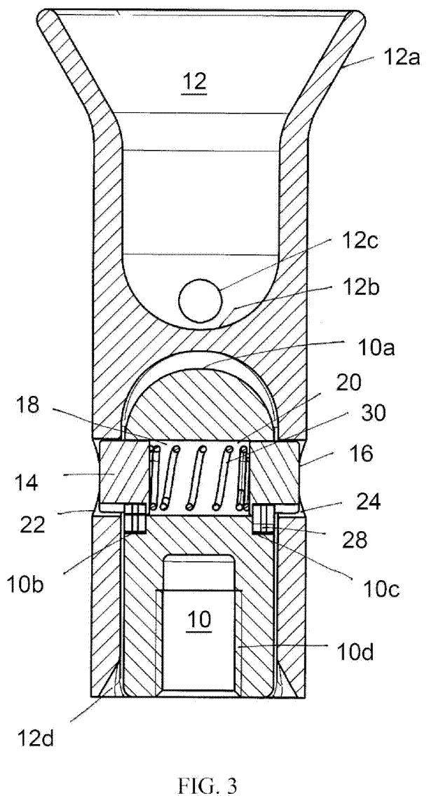

FIGS. 1a and 1b are isometric perspective views and FIGS. 2a and 2b show a cross section of a ferrule 12 and insert 10 according to an embodiment of the invention. FIG. 3 shows a cross section of the embodiment in the operating position. In the interest of clarity, every attempt has been made to keep the numbering of the same parts uniform in all drawings.

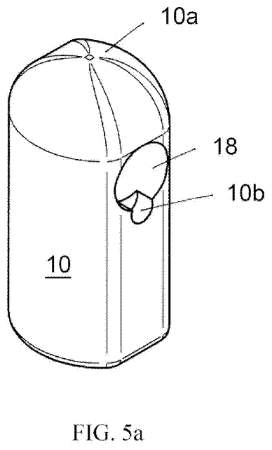

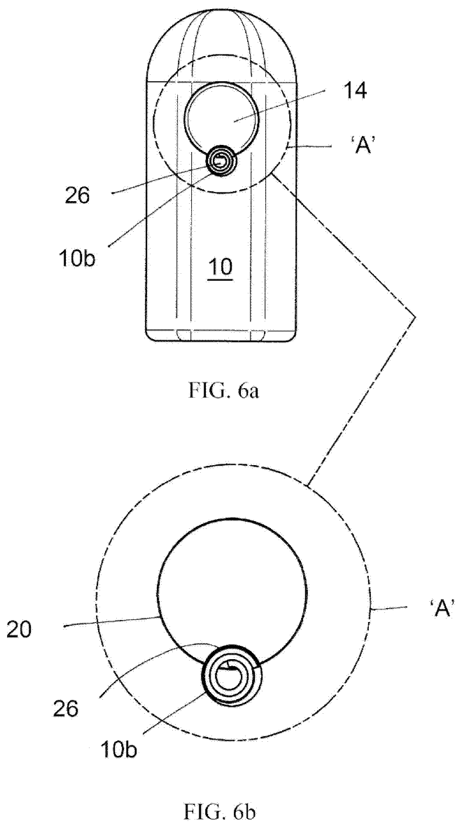

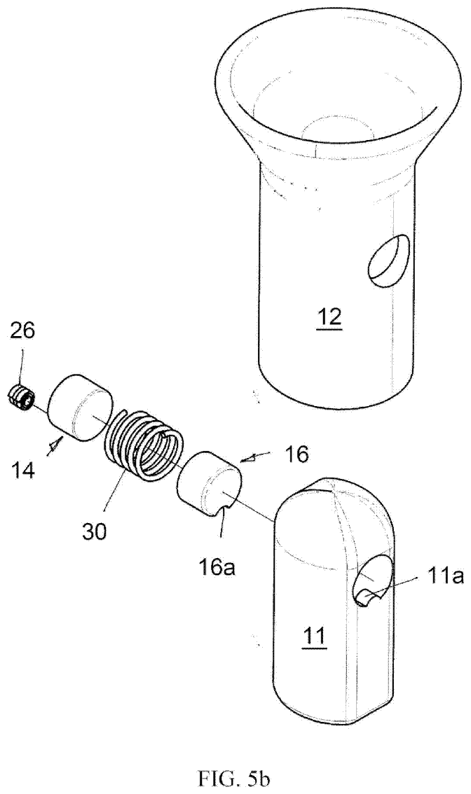

The male insert 10 to which the fixture (not shown) is connected is inserted into the female ferrule 12 which is embedded in an overhead concrete structure. The insert is associated with one or more spring loaded pins 14, 16 housed in wells 18, 20 under spring tension 30. The ferrule has apertures 22, 24 positioned to receive the pins. Spring coils 26, 28 are force fitted into eccentric blind ended grooves 10c, 10b to secure the pins in the insert. In an embodiment, the assembly may utilize one force fitted coil where the insert is cast accordingly (see discussion for FIGS. 5a-5c). The pins are pushed in against the spring 30 to allow the insert to enter the ferrule and to spring outwardly on engaging the apertures which locks the insert in the ferrule.

The upper portion of the ferrule 12a is of an inverted hollow frusta conical configuration which permanently secures the ferrule in the concrete to prevent it from being pulled out under load.

The ferrule has a blanked off portion 12b (shown in cross section in FIG. 2a) to prevent concrete from entering the ferrule and filling the apertures as it is being embedded in the wet concrete. The blank 12b is also positioned below the top of the ferrule wherein as concrete fills the upper portion of the ferrule and when hardened, prevents it from collapsing inwardly under load. There is a hole 12c in the blanked off section to allow air displaced by the wet concrete to escape.

The insert and the ferrule are shown with a complementary outer and inner elliptical shape or configuration, 10, 12d, respectively to ensure when the insert is correctly and fully inserted, the pins will align with the apertures in the ferrule. The ferrule is preferably associated with an outer sleeve or adhesive stickers (not shown) to prevent concrete from entering the one or more apertures as the ferrule is enclosed by the wet concrete.

Referring to FIG. 3 there is shown a cross-section of the example of the device in the operating position. The pins 14, 16 in the wells 18, 20 are deployed by spring 30. As previously shown in FIGS. 1b and 2b, while free to move, the pins are secured in the insert by coils 26, 28 which are force fitted into eccentric blind ended grooves 10b, 10c in the wells. The pins when fully deployed in the ferrule are held in position by coils 26, 28 against compression force exerted by spring 30.

While not shown, the insert can be associated with a removable sleeve which restrains the spring-loaded pins in the retracted position until it is dislodged as the insert enters the ferrule to allow the pins to be released and engage the apertures of the ferrule. In an embodiment, the pins are in a paired and transversely opposed arrangement.

The pins have bevelled, domed or rounded ends 10a and the apertures 22, 24 may have correspondingly bevelled or chamfered mouths to facilitate entry and full deployment of the pins in the apertures. The attachment of a fixture (not shown) to the insert can include a female screw thread 10d into which a threaded suspension rod or bolt (not shown) attaching the fixture is screwed.

Suitably, the number of apertures of the ferrule and the number of pins of the insert depend on the tensile load specified to be carried by the suspended fixtures. Suitably, the dimensions of the pins and apertures likewise depend on the specified loading requirements. Accordingly, the diameter of the pins and the composite holes are also determined by the shear load required to be borne by the pins.

The insert and the ferrule may share a complementary outer and inner elliptical shape or configuration, 10, 12d (see also FIG. 1a), to ensure the insert is correctly and fully inserted in the ferrule. In the alternative, the insert and the ferrule can be of a rectangular, or non-ellipsoid configuration to achieve the same purpose.

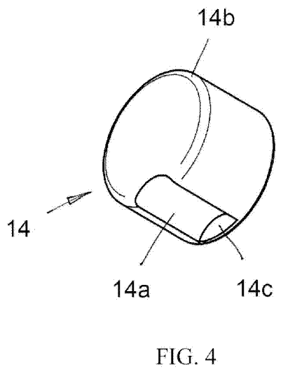

FIG. 4 shows detail of a pin 14 with blind ended pin groove 14a. The pins have bevelled, domed or rounded ends 14b to facilitate engagement with the apertures of the ferrule (not shown). Blind end 14c is adapted to be in contact with force fitted spring coil (26 in FIG. 3) in eccentric groove (10b of FIG. 3 or FIG. 5) of the insert.

FIG. 5a shows detail of the insert 10 with blind eccentric groove 10b for the housing of a force fit coil (not shown) which will protrude partially into well 18 to also engage pin groove 14a shown in FIG. 4. The insert has a domed head 10a with a complementary elliptical outer configuration to facilitate correct insertion in the complementary internal shape of the ferrule (refer 12d in FIG. 1a).

In another example, shown in FIGS. 5b and 5c (reverse view), the insert 11 is pre cast on one side with complementary protrusion 11a to engage a pin groove 16a wherein insertion of a first pin 16 and compression spring 30 is followed by the second pin 14 on the opposite side. Both pins are then secured by a single force fitted spring coil 26 in eccentric groove 11b to retain the second pin which also cuts down the assembly time. The insert, pins and spring are then supplied as a pre-assembled unit for insertion in a ferrule 12.

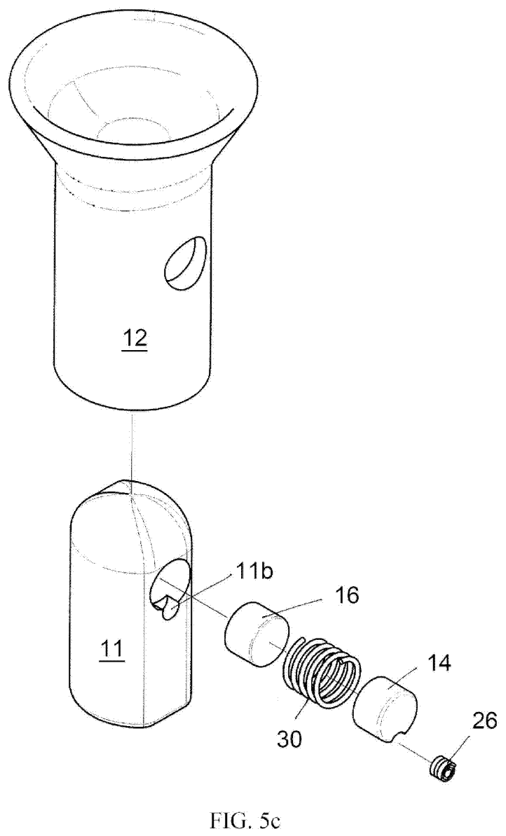

FIG. 6a shows detail of the insert 10 with force fit coil 26 to retain pin 14. FIG. 6b shows magnified detail of the area, “A” of FIG. 6a to emphasize the eccentricity of groove 10b for the housing a force fit coil 26 which protrudes partially into well 20 to retain pin 14 (by contact with pin blind end 14c of FIG. 4).

It will of course be realized that the foregoing has been given by way of illustrative example of, but not to limit, this invention, and all such and other modifications and variations thereto as would be apparent to persons skilled in the art are deemed to fall within the broad scope and ambit of this invention as is herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

1. An embedded anchor to which a fixture comprising suspension rods, studs and other steel work can be secured to a concrete structure, comprising:
a male insert to which the fixture is to be connected;
a female ferrule configured to receive the insert; the ferrule adapted to be embedded in the concrete structure;
the insert associated with one or more spring loaded pins housed in wells in the insert;
the ferrule including one or more apertures positioned to receive the one or more spring loaded pins;
the one or more spring loaded pins are pushed in against a compression spring to allow the insert to be slid into the ferrule, wherein the one or more spring loaded pins spring outwardly on engaging the one or more apertures thereby locking the insert in the ferrule to secure the fixture to the concrete structure.

2. The anchor of claim 1, wherein the one or more spring loaded pins are secured in the insert by spring coils which are force fitted into eccentric partial grooves in the wells wherein a portion of the spring coils are exposed to engage blind ended grooves in the one or more spring loaded pins thereby retaining the one or more spring loaded pins in the wells against the compression spring.

3. The anchor of claim 1, wherein the insert is pre cast on one side with a complementary protrusion to engage a pin groove of a first pin wherein insertion of the first pin and spring is followed by a second pin on the opposite side; both of the first and second pins secured by a single force fitted coil which retains the second pin and wherein the insert, first and second pins and spring are supplied as a pre-assembled unit.

4. The anchor of claim 1, wherein the ferrule is of a hollow tubular configuration with a blanked off upper portion to prevent concrete from entering the ferrule and filling the one or more apertures as it is being embedded in wet concrete.

5. The anchor of claim 1, wherein the ferrule is blanked off to allow concrete to fill an upper portion of the ferrule which prevents it from collapsing inwardly under load.

6. The anchor of claim 1, wherein an upper portion of the ferrule is wider or is of a larger size to prevent the ferrule when embedded from being pulled out of the concrete structure under load.

7. The anchor of claim 1, wherein an upper portion of the ferrule is of an inverted tubular frusta conical configuration which permanently locks the ferrule in the concrete structure.

8. The anchor of claim 5, wherein there is a hole in a blanked off section of the ferrule to allow air to escape as it is displaced by the wet concrete entering the ferrule.

9. The anchor of claim 1, wherein, the ferrule is associated with adhesive stickers or an outer sleeve to prevent concrete from entering the one or more apertures as the ferrule is embedded in wet concrete.

10. The anchor of claim 1, wherein, the insert is associated with a removable sleeve which restrains the one or more spring-loaded pins in the retracted position until it is dislodged as the insert enters the ferrule to allow the one or more spring loaded pins to be released and to engage the one or more apertures of the ferrule.

11. The anchor of claim 1, wherein, the pins are in a paired and in a transversely opposed arrangement.

12. The anchor of claim 1, wherein, the one or more spring loaded pins have bevelled, domed or rounded ends and the one or more apertures have correspondingly bevelled or chamfered mouths to facilitate entry and full deployment of the one or more spring loaded pins in the one or more apertures.

13. The anchor of claim 1, wherein the insert may include a female screw thread into which a bolt or threaded rod attaching the fixture is screwed.

14. The anchor of claim 1, wherein, the number of apertures of the ferrule and the number of pins of the insert depend on the tensile load specified to be carried by the suspended fixtures.

15. The anchor of claim 1, wherein, the dimensions of the pins and apertures depend on the specified loading requirements.

16. The anchor of claim 1, wherein, the insert and the ferrule are of a complementary shape or configuration to ensure the insert is correctly inserted in the ferrule and the one or more spring loaded pins are aligned with the one or more apertures.

17. The anchor of claim 1, wherein, the insert and the ferrule are of an elliptical shape or configuration to ensure the insert will be correctly inserted into the ferrule.

18. The anchor of claim 1, wherein, the insert and the ferrule are of a rectangular, or other non-ellipsoid or non-cylindrical configuration to ensure the insert will be correctly inserted into the ferrule.
